(19) United States
(12) Patent Application Publication
(10) Pub. No.: US 2024/0091938 A1
(43) Pub. Date: Mar. 21, 2024

(54) SYSTEM AND METHOD FOR PROVIDING IN HAND ROBOTICS DEXTEROUS MANIPULATION OF OBJECTS

(71) Applicant: Honda Motor Co., Ltd., Tokyo (JP)

(72) Inventors: Sergio AGUILERA, Atlanta, GA (US); Rana SOLTANI ZARRIN, Los Gatos, CA (US)

(21) Appl. No.: 18/090,967

(22) Filed: Dec. 29, 2022

Related U.S. Application Data
(60) Provisional application No. 63/407,445, filed on Sep. 16, 2022.

(51) Int. Cl. B25J 9/16; B25J 15/10

(52) U.S. Cl. CPC B25J 9/1664; B25J 9/1697; B25J 15/10

(57) ABSTRACT

A system and method for providing in hand robotics dexterous manipulation of an object that include determining a geometry of an object, a position of the object, and a placement of at least one robotic finger of a robot upon the object. The system and method also include computing a direction of rolling or rotation of the object by the at least one robotic finger. The system and method additionally include updating a position of the object that is manipulated by the robot. The system and method further include updating contact points of the at least one robotic finger with respect to contacting the object in a manner that ensures that a viable grasp is enforced to have force closure to retain the object.

### CROSS-REFERENCE TO RELATED APPLICATION

This application claims priority to U.S. Provisional Application Ser. No. 63/407,445 filed on Sep. 16, 2022, which is expressly incorporated herein by reference.

### BACKGROUND

In hand manipulation requires fine motion of the fingers to hold and repose an object. Finger gaiting, sliding, and rolling are some of the behaviors which may enable complex dexterous manipulation tasks. In previous works, the concept of rolling of an object in hand, by moving fingers in contact to accomplish a desired change in orientation of a curved object has been studied. In many cases rolling of objects have been evaluated with respect to lifting of one or more fingers to reach a desired object orientation. However, this results in the changing of finger gaits which may require wrist, hand, and joint movements to be completed which may require complex processes to be executed.

### BRIEF DESCRIPTION

According to one aspect, a computer-implemented method for providing in hand robotics dexterous manipulation of an object. The computer-implemented method includes determining a geometry of an object, a position of the object, and a placement of at least one robotic finger of a robot upon the object. The computer-implemented method also includes computing a direction of rolling or rotation of the object by the at least one robotic finger. The computer-implemented method additionally includes updating a position of the object that is manipulated by the robot. The position of the object is updated based on a motion of joints of the at least one robotic finger. The computer-implemented method further includes updating contact points of the at least one robotic finger with respect to contacting the object in a manner that ensures that a viable grasp is enforced to have force closure to retain the object.

According to another aspect, a system for providing in hand robotics dexterous manipulation of an object that includes a memory that stores instructions that are executed by a processor. The instructions include determining a geometry of an object, a position of the object, and a placement of at least one robotic finger of a robot upon the object. The instructions also include computing a direction of rolling or rotation of the object by the at least one robotic finger. The instructions additionally include updating a position of the object that is manipulated by the robot. The position of the object is updated based on a motion of joints of the at least one robotic finger. The instructions further include updating contact points of the at least one robotic finger with respect to contacting the object in a manner that ensures that a viable grasp is enforced to have force closure to retain the object.

According to yet another aspect, a non-transitory computer readable storage medium storing instructions that when executed by a computer, which includes a processor performs a method. The method includes determining a geometry of an object, a position of the object, and a placement of at least one robotic finger of a robot upon the object. The method also includes computing a direction of rolling or rotation of the object by the at least one robotic finger. The method additionally includes updating a position of the object that is manipulated by the robot. The position of the object is updated based on a motion of joints of the at least one robotic finger. The method further includes updating contact points of the at least one robotic finger with respect to contacting the object in a manner that ensures that a viable grasp is enforced to have force closure to retain the object.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary operating environment for providing in hand robotics dexterous manipulation for objects according to an exemplary embodiment of the present disclosure;

FIG. 2 is an illustrative example of the robotic hand of a robot according to an exemplary embodiment of the present disclosure;

FIG. 3 is a schematic overview of an object manipulation application according to an exemplary embodiment of the present disclosure;

FIG. 4 is an illustrative example of an object rolling about its rotation axis according to an exemplary embodiment of the present disclosure;

FIG. 5 is a process flow for controlling the robot with a sufficient force closure that is required to continue to grasp and manipulate the object as it is rolled or rotated according to an exemplary embodiment of the present disclosure;

FIG. 6 is a process flow diagram of a method for providing in hand robotics dexterous manipulation of an object according to an exemplary embodiment of the present disclosure;

FIG. 7 is an illustration of an example computer-readable medium or computer-readable device including processor-executable instructions configured to embody one or more of the provisions set forth herein according to an exemplary embodiment of the present disclosure; and

FIG. 8 is an illustration of an example computing environment where one or more of the provisions set forth herein are implemented according to an exemplary embodiment of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

“Computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “disk”, as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

A “memory”, as used herein may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory may store an operating system that controls or allocates resources of a computing device.

A “module”, as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discreet logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

An “operable connection”, or a connection by which entities are “operably connected”, is one in which signals, physical communications, and/or logical communications may be sent and/or received. An operable connection may include a wireless interface, a physical interface, a data interface and/or an electrical interface.

A “processor”, as used herein, processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

A “vehicle”, as used herein, refers to any moving vehicle that is capable of carrying one or more human occupants and is powered by any form of energy. The term “vehicle” includes, but is not limited to: cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” may refer to an electric vehicle (EV) that is capable of carrying one or more human occupants and is powered entirely or partially by one or more electric motors powered by an electric battery. The EV may include battery electric vehicles (BEV) and plug-in hybrid electric vehicles (PHEV). The term “vehicle” may also refer to an autonomous vehicle and/or self-driving vehicle powered by any form of energy. The autonomous vehicle may or may not carry one or more human occupants. Further, the term “vehicle” may include vehicles that are automated or non-automated with pre-determined paths or free-moving vehicles.

A “value” and “level”, as used herein may include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage between 0% and 100%. In other cases, the value or level of X could be a value in the range between 1 and 10. In still other cases, the value or level of X may not be a numerical value, but could be associated with a given discrete state, such as “not X”, “slightly x”, “x”, “very x” and “extremely x”.

### I. System Overview

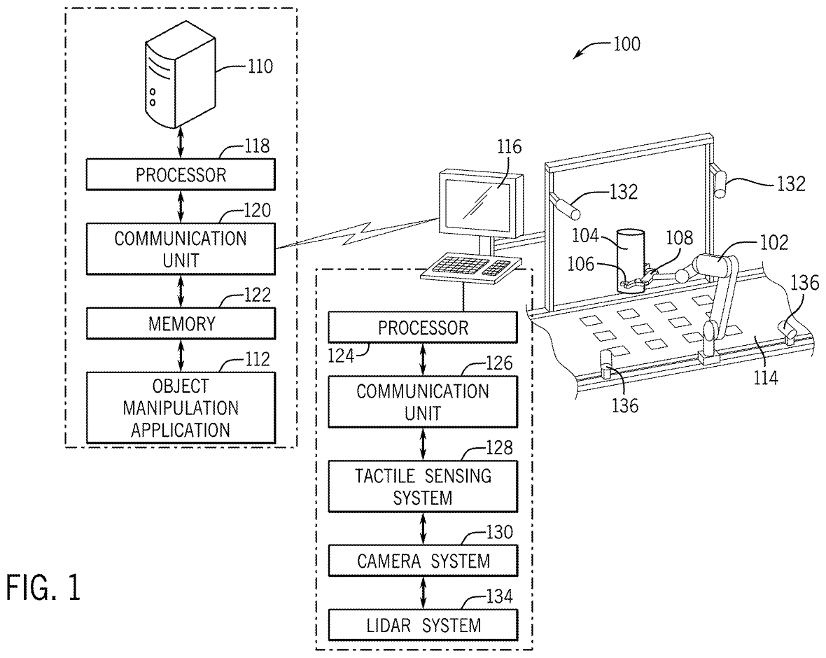

Referring now to the drawings, wherein the showings are for purposes of illustrating one or more exemplary embodiments and not for purposes of limiting the same, FIG. 1 is a schematic view of an exemplary operating environment 100 for providing in hand robotics dexterous manipulation for objects according to an exemplary embodiment of the present disclosure. The operating environment 100 includes a system that enables a robot 102 to continuously manipulate an object 104 using one or more robotic fingers 106 of a robotic hand 108.

In an exemplary embodiment, the operating environment 100 may include an externally hosted server infrastructure (external server) 110 that may be configured to execute an object manipulation application 112. As discussed in more detail below, the object manipulation application 112 may be configured to utilize robotic hand movements to manipulate the object 104 that is being grasped by one or more robotic fingers 106 of the robotic hand 108 in a manner that ensures that a viable grasp of the object 104 is maintained to have force closure in order to retain the object 104 as it is manipulated.

In one or more embodiments, the object 104 may be configured as a cylindrical object that may be capable of being manipulated by being rolled or rotated by one or more robotic fingers 106 of the robotic hand 108. The object 104 may be rolled or rotated by the one or more robotic fingers 106 as the object 104 is grasped by one or more robotic fingers 106 or as the object 104 is placed upon a surface 114. In other words, the object 104 may be manipulated by being rolled or rotated to be turned as it is grasped by one or more of the robotic fingers 106 as its being held by the robotic hand 108 or as its placed upon the surface 114 and being grasped by the robotic fingers 106 to roll or rotate the object 104 upon the surface 114.

In one configuration, the object 104 may be cylindrical in shape and may be configured to be grasped at one or more portions of the object 104 by one or more robotic fingers 106 of the robotic hand 108. For example, the object 104 may be a cylindrical tool, part, apparatus, and/or utensil that may be manipulated by the robotic hand 108 to complete a rolling or rotating motion to accomplish a particular task. As an illustrative example, the object 104 may include a cylindrical handle portion of a screwdriver (not shown) that may be manipulated by being rotated by one or more robotic fingers 106 to complete a particular task.

In another configuration, the object 104 may be spherical in shape and may be configured to be grasped at one or more portions of the object 104 by one or more robotic fingers 106 of the robotic hand 108. For example, the object 104 may be a ball that may be manipulated by the robotic hand 108 by completing a rolling motion upon the surface 114.

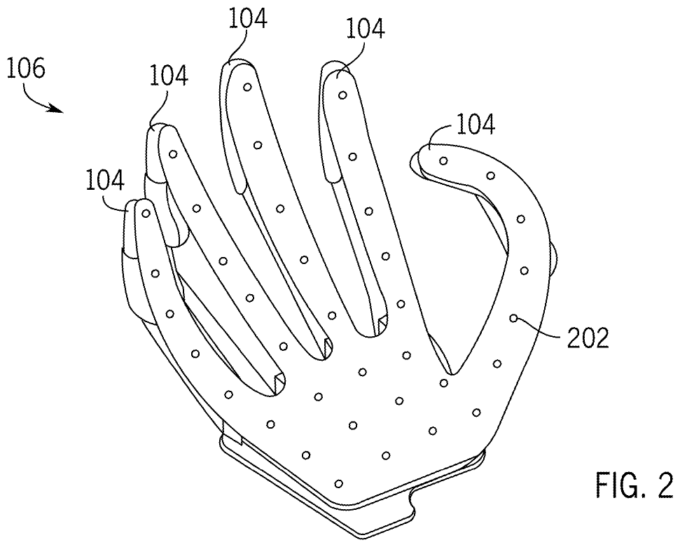

FIG. 2 includes an illustrative example of the robotic hand 108 of the robot 102 according to an exemplary embodiment of the present disclosure. As shown in the illustrative embodiment of FIG. 2, one or more of the robotic fingers 106 of the robotic hand 108 may be configured to be similar in shape, curvature, and functionality to a human hand. In alternate embodiments, one or more of the robotic fingers 106 may be configured as one or more grippers (as shown in FIG. 1). In additional embodiments, one or more of the robotic fingers 106 may be configured as including wide fingertips, narrow fingertips, curved finger tips, and/or fingertips that are composed of particular materials (e.g., rubbery fingertips) to grasp, grip, and manipulate the object 104. However, it is to be appreciated that the robotic hand 108 and/or one or more of the robotic fingertips of one or more robotic fingers 106 may be configured in a variety of form factors, shapes, sizes, and of a variety of materials.

With continued reference to FIG. 1 and FIG. 2, as discussed in more detail below, the object manipulation application 112 may be configured to determine that one or more robotic fingers 106 of the robot 102 may be grasping the object 104 based on tactile sensor data that may be provided by tactile sensors 202 that may be disposed upon one or more of the robotic fingers 106 and/or one or more portions of the robotic hand 108. The object manipulation application 112 may be configured to receive image data and/or LiDAR data and may determine a geometry of the object 104 and a position of the object 104 as the object 104 is grasped by one or more of the robotic fingers 106.

The object manipulation application 112 may be configured to compute a direction of rolling or rotating of the object 104 as its being grasped by one or more of the robotic fingers 106. In particular, the object manipulation application 112 may be configured to compute a required motion of joints of one or more robotic fingers 106. As discussed below, the object manipulation application 112 may also be configured to compute a Jacobian of one or more of the robotic fingers 106 of the robot 102 at a current joint configuration to transform the motion of the rolling direction or rotating direction into joint motions of one or more of the robotic fingers 106.

Upon transforming the motion of the rolling direction or rotating direction into the joint motions, the object manipulation application 112 may be configured to update a position of the object 104 that is manipulated by the robot 102 by a rotation of the object 104. The object manipulation application 112 may be configured to update contact points of one or more of the robotic fingers 106 with respect to contacting of the object 104 in a manner that ensures that a viable grasp is continually enforced to have force closure to retain the object 104 as it continues to be manipulated (rolled or rotated). Accordingly, the object manipulation application 112 may be configured to send one or more commands to a robotic computing system 116 that is associated with the robot 102 to electronically control one or more robotic fingers 106 of the robotic hand 108 in one or more steps based on the updated contact points to continue to manipulate the object 104. The robot 102 may thereby be electronically controlled to roll or rotate the object 104 while ensuring that a viable grasp is continually enforced upon the object 104.

It is appreciated that the functionality of object manipulation application 112 may be used for additional robotic applications in addition or in lieu of grasping and/or manipulation of cylindrical or spherical objects. For example, the functionality of the object manipulation application 112 may be used to update contact points of one or more of the robotic fingers 106 with respect to contacting of a semi-circular shaped object in a manner that ensure that a viable grasp is continually enforced to have force closure to be retained as its manipulated.

The object manipulation application 112 may provide an improvement in the technology of robotic manipulation of rolling of objects or rotation of objects that is accomplished in an efficient manner without the lifting and repositioning of robotic fingers. This improvement to the technology allows for the updating of the context of the object 104 and maintaining a force closure of the object 104 while completing a rolling motion or rotational motion by one or more robotic fingers 106 during the manipulation of the object 104. This functionality avoids the execution of complex processes that pertains to unnecessary movements that would need to be completed by robotic arms, robotic wrists, robotic joints, and/or robotic hands to maintain a proper grasp of the object 104.

With continued reference to FIG. 1, the external server 110 may be operably controlled by a processor 118 that may be configured to execute the object manipulation application 112. In particular, the processor 118 may be configured to execute one or more applications, operating systems, databases, and the like. The processor 118 may also include internal processing memory, an interface circuit, and bus lines for transferring data, sending commands, and communicating with the plurality of components of the external server 110.

The processor 118 may be operably connected to a communications unit 120 of the external server 110. The communications unit 120 may include one or more network interface cards (not shown) that may be configured to connect to one or more computing systems through an internet cloud (not shown). In particular, the communications unit 120 may be configured to provide secure communications between the external server 110 and the robotic computing system 116 to facilitate the communication of data between the object manipulation application 112 and the components disposed upon and associated with the robot 102.

In one embodiment, the processor 118 may be operably connected to a memory 122 of the external server 110. Generally, the processor 118 may communicate with the memory 122 to execute the one or more applications, operating systems, and the like that are stored within the memory 122. In one embodiment, the memory 122 may store one or more executable application files that are associated with the object manipulation application 112. In one or more embodiments, the memory 122 may be configured to store one or more pre-trained datasets (not shown) that may be populated with values that are associated with the grasping and manipulation of objects. Upon determining and updating the contact points of one or more robotic fingers 106, values associated with the updated contact points may be stored upon the memory 122. The stored values may be retrieved and analyzed to determine if contact points of one or more of the robotic fingers 106 may need to be updated to maintain force closure upon the object 104 during the manipulation of the object 104.

As discussed, the robotic computing system 116 may be associated with the robot 102. The robotic computing system 116 may be operably controlled by a processor 124. In some embodiments, the processor 124 of the robotic computing system 116 may be configured to execute the object manipulation application 112. The processor 124 may also include internal processing memory, an interface circuit, and bus lines for transferring data, sending commands, and communicating with the plurality of components of the robot 102, the robotic hand 108 and/or one or more of the robotic fingers 106.

The processor 124 may be operably connected to a communications unit 126 of the robotic computing system 116. The communications unit 126 may include one or more network interface cards (not shown) that may be configured to connect to one or more computing systems through an internet cloud (not shown). In particular, the communications unit 126 may be configured to provide secure communications between the robotic computing system 116 and the external server 110 to facilitate the communication of data between the object manipulation application 112 and the components disposed upon and associated with the robot 102.

In one or more embodiments, the robotic computing system 116 may be operably connected to a tactile sensing system 128 and may receive tactile sensing data from the tactile sensing system 128. The tactile sensing data may be provided based on tactile measurements that may be sensed by the tactile sensors 202 that may be disposed upon one or more of the robotic fingers 106 and/or one or more portions of the robotic hand 108.

As represented in FIG. 2, the plurality of tactile sensors 202 may be disposed upon a surface of the robotic hand 108 and upon the one or more robotic fingers 106. The plurality of tactile sensors 202 may be configured as capacitive sensors, piezoresistive sensors, piezoelectric sensors, optical sensors, elastoresistive sensors, inductive sensors, and/or proximity sensors. The plurality of tactile sensors 202 may be configured to provide tactile data that is associated with sensed contact forces that may be measured in response to the physical interaction between one or more robotic fingers 106 and the object 104. Accordingly, as the object 104 is grasped by one or more of the robotic fingers 106 of the robotic hand 108, the plurality of tactile sensors 202 may be configured to provide tactile data that pertains to the forces associated with respect to the contact between one or more of the robotic fingers 106 and the object 104.

In one embodiment, upon sensing contact forces that may be measured in response to the physical interaction between one or more robotic fingers 106 and the object 104 as the robotic hand 108 grasps the object 104, the plurality of tactile sensors 202 may be configured to communicate the tactile data to the tactile sensing system 128. The object manipulation application 112 may be configured to communicate with the tactile sensing system 128 and may receive the tactile sensing data associated with the sensed contact forces that may be measured in response to the physical interaction between respective robotic fingers 106 and the object 104. As discussed below, the object manipulation application 112 may be configured to analyze the tactile data received from the tactile sensing system 128 and may determine contact points that pertain to the specific placement of one or more robotic fingers 106 upon the object 104 as it is being grasped.

With continued reference to FIG. 1, in one or more embodiments, the robotic computing system 116 may be operably connected to a camera system 130. The camera system 130 may be operably connected to a plurality of cameras 132 that may be configured to capture images of the robot 102 and the object 104 as its being grasped and manipulated by the robot 102. The camera system 130 may provide image data that may be associated with the images. The image data may include data associated with single view or multi-view video of the robot 102 and the object 104 as its being grasped and manipulated by the robot 102.

In one embodiment, upon capturing images of the robot 102 and the object 104, the plurality of cameras 132 may be configured to communicate the image data associated with the images of the object 104 as its being grasped and manipulated by the robot 102 to the camera system 130. As discussed below, the object manipulation application 112 may be configured to analyze the image data and may determine a geometry and position of the object 104.

In one or more embodiments, the robotic computing system 116 may be operably connected to a LiDAR system 134. The LiDAR system 134 may be operably connected to a plurality of LiDAR sensors 136. In one configuration, the plurality of LiDAR sensors 136 may be configured to include dimensional LiDAR emitting devices that may be configured to oscillate and emit one or more laser beams of ultraviolet, visible, or near infrared light toward the object 104. The plurality of LiDAR sensors 136 may be configured to receive one or more reflected laser waves (e.g., signals) that are reflected off the robot 102 and the object 104 and may determine position, geometry, and depth data associated with the object 104 that is output in the form of a 3D point cloud.

In one or more embodiments, upon determining the 3D point cloud associated with the robot 102 and the object 104, the plurality of LiDAR sensors 136 may be configured to communicate LiDAR data that includes information pertaining to the 3D point cloud to the LiDAR system 134. As discussed below, the object manipulation application 112 may be configured to communicate with the LiDAR system 134 to receive the LiDAR data and may analyze the LiDAR data to determine a geometry and pose of the object 104.

### II. The Object Manipulation Application and Related Methods

Components of the object manipulation application 112 will now be described according to an exemplary embodiment and with continued reference to FIG. 1 and FIG. 2. In an exemplary embodiment, the object manipulation application may be stored on the memory 122 and may be executed by the processor 118 of the external server 110. In another embodiment, the object manipulation application 112 may be executed through the processor 124 of the robotic computing system 116 based on storage of the application 112 on a storage unit (not shown) of the robotic computing system 116 and/or based on wireless communications between the communications unit 126 of the robotic computing system 116 and the communications unit 120 of the external server 110.

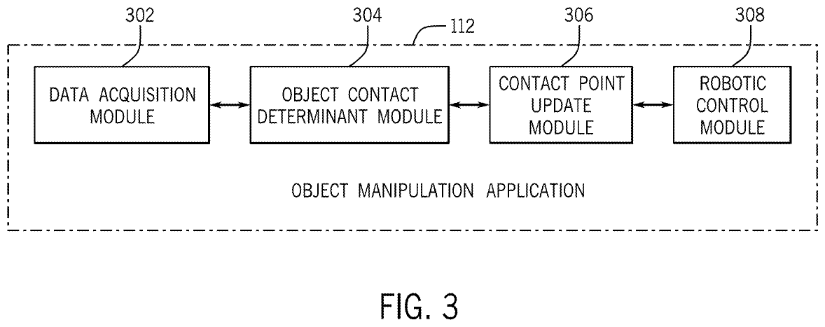

FIG. 3 is a schematic overview of the object manipulation application 112 according to an exemplary embodiment of the present disclosure. In an exemplary embodiment, the object manipulation application 112 may include a plurality of modules 302-308 that may be configured to provide in hand robotics dexterous manipulation of objects by the robot 102. The plurality of modules 302-308 may include a data acquisition module 302, an object contact determinant module 304, a contact point update module 306, and a robotic control module 308. However, it is appreciated that the object manipulation application 112 may include one or more additional modules and/or sub-modules that are included in lieu of the modules 302-308.

In an exemplary embodiment, the object manipulation application 112 may be configured to provide the framework to execute computer-implemented processes that may be executed with respect to the manipulation of the object 104 by the robotic hand 108. An overview of the framework will now be described. As discussed below, the object manipulation application 112 may be configured to keep track of changing contact points with respect to one or more of the robotic fingers 106 and the object 104. In particular, the object manipulation application 112 may be configured to keep track of changing contact points with respect to both the object 104 and the robot 102 to keep the object 104 within a viable grasp of the robotic hand 108 of the robot 102 as the object 104 is being rolled or rotated by one or more robotic fingers 106 of the robotic hand 108.

The object manipulation application 112 may be configured to evaluate the roll or rotation of the object 104 as a rotation primitive. The rotation primitive may include a sequence of motions that enable the object 104 to be rolled or rotated about its axis as the contact points between one or more robotic fingers 106 and the object 104 changes. In one configuration, the object manipulation application 112 may be configured to consider the object 104 as being placed upon the surface 114, with a rotation axis given by R and a contact point p(t). The object manipulation application 112 may be configured to operably control the robot 102 to place at least one contact point of at least one robotic finger 106 that is opposite to the ground or surface 114 and may apply a normal force N onto the object 104 to ensure that the object 104 stays in place.

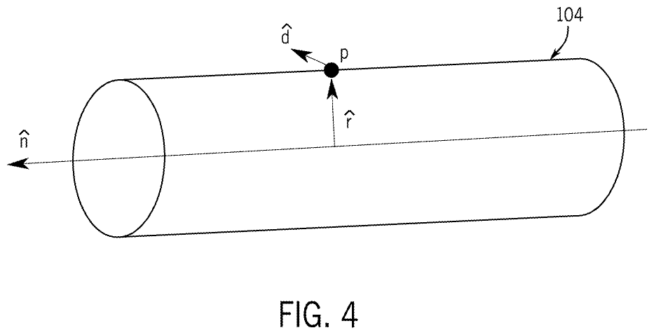

As represented in FIG. 4, to make the object 104 roll about its rotation axis \hat{n}, the robot 102 may be configured to move respective fingertips of one or more robotic fingers 106 perpendicular to both the rotation axis R and a vector between the rotation axis and the contact point r. The desired direction of the motion of each of the fingertips of the one or more robotic fingers 106 may be given by the cross product:

d=\hat{n}×\hat{r}.

In one configuration, to roll or rotate the object 104, the object manipulation application 112 may be configured to operably control the robot 102 to apply a normal force onto the object 104, such that there is enough friction to have the object 104 move along the respective fingertips of one or more of the robotic fingers 106. In one embodiment, the object manipulation application 112 may be configured to compute the required motion of the joints of the robotic hand 108 such that:

\hat{\dot{q}}(t)=J(q(t))\hat{d}

where J(q(t)) is the Jacobian of the robot 102 at the current joint configuration q. Considering that \hat{d} lives in the span of J(q(t)) and that the robot 102 is not in a singular configuration, the object manipulation application 112 may be configured to send one or more commands to the robot 102 to move its joints in the given direction. At each time step t, t+n, it may be necessary to update the contact point location of the one or more robotic fingers 106 with respect to the object 104.

In one embodiment, if one or more robotic fingers 106 are configured to include wide fingertips, the object manipulation application 112 may analyze the velocity of the contact point in the finger frame as being opposite to the direction of motion of the object 104 (−d). For the object 104, the contact point may move along the object's surface in the negative direction of the motion of the object 104. The length of the segment traveled on the object surface and one or more robotic fingers 106 is the same Δs. The rotation of the object 104 by this motion may be given by:

Δs=|\hat{r}|Δθ

In term of forces that are applied by a single robotic finger, the object manipulation application 112 may be configured to consider the normal force N and the tangential force Fₜ in the direction of \hat{d}. To have a successful motion, the object manipulation application 112 may be configured to ensure that the vector of the forces are inside a friction cone of the contact point between the robotic finger 106 and the object 104. Here, the translation velocity of the object 104 may be equal to the velocity of the contact point on the robotic finger 106. By computing the direction d for each contact point i, the object manipulation application 112 may be thereby configured to compute a single finger motion step to perform a rolling or rotating motion.

With respect to multiple finger rolling, if the object 104 is in a grasp position, where two or more robotic fingers 106 are holding the object 104, the object manipulation application 112 may execute a process that updates all the contact points as the object 104 is moved. Holding the object 104 with two or more robotic fingers 106 and moving only one robotic finger to roll or rotate the object 104 may also change the rolling contact on an additional robotic finger. Accordingly, when performing a rolling or rotating motion, the object manipulation application 112 may be configured to check if the updated position of all contact points allow the robot 102 to keep force closure and hold on to the object 104.

The object manipulation application 112 may be further configured to update all contact point positions and to continually check for force closure with respect to the utilization of multiple robotic finger contact points. In some embodiments, the object manipulation application 112 may be configured to execute instructions to send one or more commands to the robot 102 to move multiple robotic fingers 106 simultaneously. Considering a two finger grasp, if a single robotic finger is moved, the object 104 may rotate and translate with the same linear velocity as the robotic finger 106. If both robotic fingers are moved, the object 104 may roll and translate with a velocity equal to the difference between the finger velocities of the two robotic fingers 106. Accordingly, the object manipulation application 112 may be configured to utilize this framework to control the robot 102 to roll or rotate the object 104 in place, for example, to perform a screwing motion without rotating a base of the robotic hand 108.

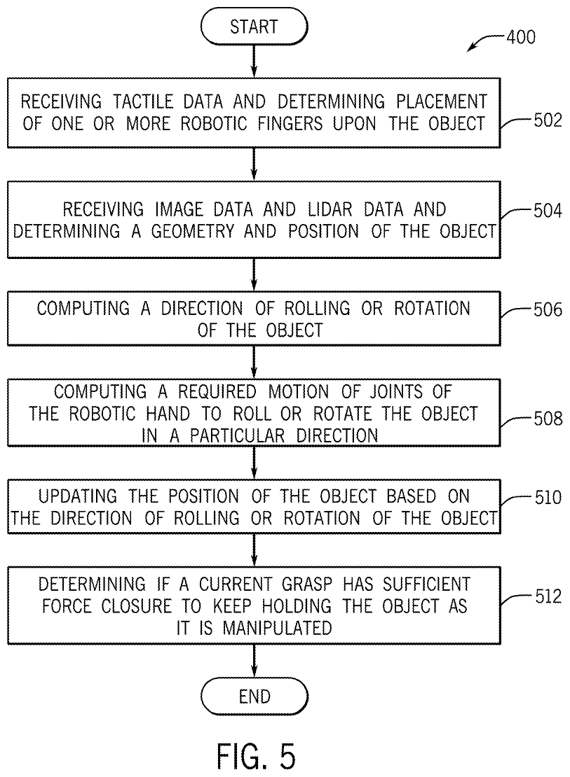

FIG. 5 is a process flow for controlling the robot 102 with a sufficient force closure that is required to continue to grasp and manipulate the object 104 as it is rolled or rotated according to an exemplary embodiment of the present disclosure. FIG. 5 will be described with reference to the components of FIG. 1, FIG. 2, FIG. 3, and FIG. 4, though it is to be appreciated that the method 500 of FIG. 5 may be used with other systems/components. The method 500 may begin at block 502, wherein the method 500 may include receiving tactile data and determining placement of one or more robotic fingers 106 upon the object 104.

In an exemplary embodiment, the data acquisition module 302 of the object manipulation application 112 may be configured to communicate with the tactile sensing system 128 to receive tactile sensing data from the tactile sensing system 128. The tactile sensing data may be provided based on tactile measurements that may be sensed by the tactile sensors 202 that may be disposed upon one or more of the robotic fingers 106 and/or one or more portions of the robotic hand 108. In particular, the tactile sensing data may be associated with the sensed contact forces that may be measured in response to the physical interaction between respective robotic fingers 106 and the object 104.

In one or more embodiments, upon receiving the tactile sensing data, the data acquisition module 302 may be configured to communicate the tactile sensing data to the object contact determinant module 304 of the object manipulation application 112. The object contact determinant module 304 may be configured to analyze the tactile sensing data and may determine contact points that pertain to the specific placement of one or more robotic fingers 106 upon the object 104 as it is being grasped. This determination may allow the object manipulation application 112 to analyze the specific placement of the robotic hand 108 upon the object 104 as an initial contact point determination with respect to the grasping and manipulation of the object 104.

The method 500 may proceed to block 504, wherein the method 500 may include receiving image data and LiDAR data and determining a geometry and position of the object 104. In an exemplary embodiment, the data acquisition module 302 may be configured to communicate with the camera system 130 to receive image data. As discussed above, the image data may be associated with single view or multi-view video of the robot 102 and the object 104 as its being grasped and manipulated by the robot 102 as captured by the plurality of cameras 132. Upon receiving the image data, the data acquisition module 302 may be configured to communicate the image data to the object contact determinant module 304.

The data acquisition module 302 may also be configured to communicate with the LiDAR system 134 to receive LiDAR data. As discussed above, the LiDAR data may be associated with a 3D point cloud associated with the robot 102 and the object 104 based on one or more reflected laser waves (e.g., signals) that are emitted by the plurality of LiDAR sensors 136 reflected off the robot 102 and the object 104. In one embodiment, the data acquisition module 302 may be configured to communicate the LiDAR data to the object contact determinant module 304.

Upon receiving the image data and the LiDAR data, the object contact determinant module 304 may be configured to aggregate the image data and the LiDAR data and may analyze the aggregated image data and LiDAR data to determine a geometry of the object 104. The geometry of the object 104 may pertain to a shape of the object 104, a size of the object 104, a curvature of the object 104, and/or dimensions of the object 104 being grasped by the robotic hand 108. Additionally, the object contact determinant module 304 may be configured to analyze the aggregated image data and LiDAR data to determine a position of the object 104 that may pertain to a pose of the object 104, the location of the object 104, and a displacement of the object 104 during one or more points in time.

The method 500 may proceed to block 506, wherein the method 500 may include computing a direction of rolling or rotation of the object 104. In an exemplary embodiment, upon determining the placement of one or more robotic fingers 106 upon the object 104 and determining the geometry and the position of the object 104 as the object 104 is being grasped and manipulated by the robot 102, the object contact determinant module 304 may be configured to compute the direction of rolling or rotation \hat{d} with respect to each of the one or more robotic fingers 106 i. Upon computing the direction of rolling or rotation \hat{d} of the object 104 with respect to each of the one or more robotic fingers 106 i, the object contact determinant module 304 may be configured to communicate respective data associated with the rolling or rotation \hat{d} to the contact point update module 306 of the object manipulation application 112.

The method 500 may proceed to block 508, wherein the method 500 may include computing a required motion of joints of the robotic hand 108 to roll or rotate the object 104 in a particular direction. In an exemplary embodiment, the contact point update module 306 may analyze the rolling or rotation \hat{d} of the object 104 as its being grasped by the robot 102 and may be configured to determine one or more contact points of one or more robotic fingers 106 that are to be updated to further roll or rotate the object 104 in the direction \hat{d}.

In one configuration, the contact point update module 306 may be configured to compute a required motion of joints of the robotic hand 108 such that:

\hat{\dot{q}}(t)=J(q(t))\hat{d}

where J(q(t)) is the Jacobian of the robot 102 at the current joint configuration q. Upon computing the required motion of joints of the robotic hand 108, the contact point update module 306 may communicate respective data to the robot control module 308 of the object manipulation application 112.

The method 500 may proceed to block 510, wherein the method 500 may include updating the position of the object 104 based on the direction of rolling or rotation of the object 104. In an exemplary embodiment, the robot control module 308 may be configured to send one or more commands to the robotic computing system 116 that is associated with the robot 102 to electronically control one or more robotic fingers 106 of the robotic hand 108 in one or more steps based on the computed required motion of joints of the robotic hand 108. The robot 102 may thereby be electronically controlled to roll or rotate the object 104 to further roll or rotate the object 104 in the direction d. The robot control module 308 may be configured to thereby update the position of the object 104 by a given AB rotation. Accordingly, the robot 102 may update all contact points upon the object 104 with respect to the one or more robotic fingers 106 that are in contact with the object 104.

The method 500 may proceed to block 512, wherein the method 500 may include determining if a current grasp has sufficient force closure to keep holding the object 104 as it is manipulated. In an exemplary embodiment, upon updating of the contact points by the robot 102, the robot control module 308 may be configured to provide data associated with the updated contact points to the contact point update module 306. In one embodiment, the contact point update module 306 may be configured to analyze the updated contact points with respect to the geometry and position of the object 104 to determine if the current grasp of the object 104 is sufficient with respect to the force required to continue to hold onto the object 104 and to further roll or rotate the object 104.

As discussed above, the memory 122 may be configured to store one or more pre-trained datasets that may be populated with values that are associated with the grasping and manipulation of objects. Upon determining and updating the contact points of one or more robotic fingers 106, values associated with the updated contact points may be stored upon the memory 122. In one embodiment, the contact point update module 306 may access the memory 122 and retrieve the stored values. The contact point update module 306 may be configured to analyze the retrieved values to determine if contact points of one or more of the robotic fingers 106 may need to be updated to maintain force closure upon the object 104 during the manipulation of the object 104.

If it is determined that the contact points of one or more of the robotic fingers 106 need to be updated to maintain force closure upon the object 104, the contact point update module 306 may be configured to communicate respective data to the robot control module 308. The robot control module 308 may be configured to thereby send one or more commands to the robotic computing system 116 that is associated with the robot 102 to electronically control one or more robotic fingers 106 of the robotic hand 108 to complete a required motion of joints in one or more steps based on the computed required motion of joints of the one or more robotic fingers 106 to maintain force closure of the object 104. The robot 102 may thereby be electronically controlled to continuing to maintain force closure upon the object 104 and to manipulate the object 104 by further rolling or rotating the object 104 in the direction \hat{d}.

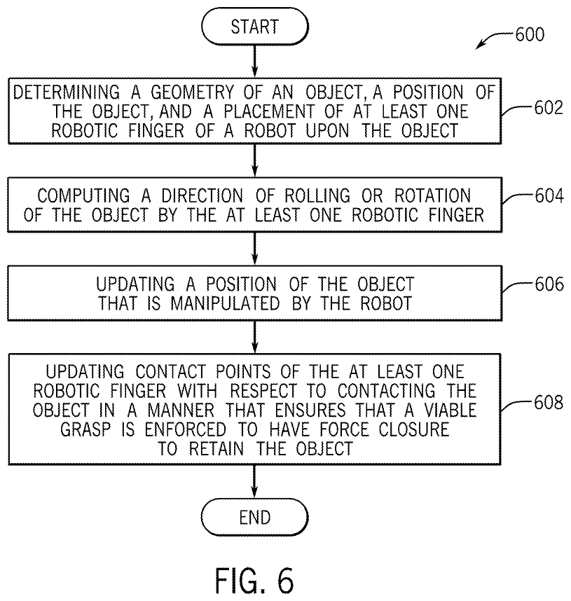

FIG. 6 is a process flow diagram of a method 600 for providing in hand robotics dexterous manipulation of an object 104 according to an exemplary embodiment of the present disclosure. FIG. 6 will be described with reference to the components of FIG. 1, FIG. 2, FIG. 3, and FIG. 4, though it is to be appreciated that the method 500 of FIG. 5 may be used with other systems/components. The method 600 may begin at block 602, wherein the method 600 may include determining a geometry of an object 104, a position of the object 104, and a placement of at least one robotic finger of a robot 102 upon the object 104.

The method 600 may proceed to block 604, wherein the method 600 may include computing a direction of rolling or rotation of the object 104 by the at least one robotic finger 106. In one embodiment, the direction of the rolling or rotation is determined by a computation of a required motion of joints of the at least one robotic finger 106. The method 600 may proceed to block 606, wherein the method 600 may include updating a position of the object 104 that is manipulated by the robot 102. The method 600 may proceed to block 608, wherein the method 600 may include updating contact points of the at least one robotic finger 106 with respect to contacting the object 104 in a manner that ensures that a viable grasp is enforced to have force closure to retain the object 104.

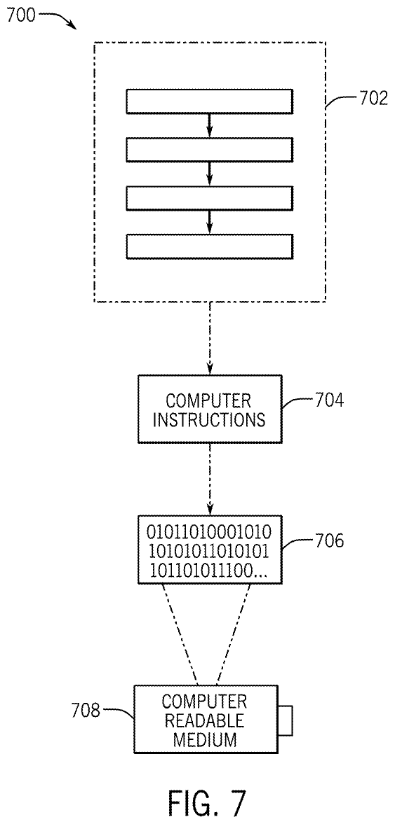

Still another aspect involves a computer-readable medium including processor-executable instructions configured to implement one aspect of the techniques presented herein. An aspect of a computer-readable medium or a computer-readable device devised in these ways is illustrated in FIG. 7, wherein an implementation 700 includes a computer-readable medium 708, such as a CD-R, DVD-R, flash drive, a platter of a hard disk drive, etc., on which is encoded computer-readable data 706. This encoded computer-readable data 706, such as binary data including a plurality of zero's and one's as shown in 706, in turn includes a set of processor-executable computer instructions 704 configured to operate according to one or more of the principles set forth herein. In this implementation 700, the processor-executable computer instructions 704 may be configured to perform a method, such as the method 500 of FIG. 5 and/or the method 600 of FIG. 6. In another aspect, the processor-executable computer instructions 704 may be configured to implement a system, such as the system included within the operating environment 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

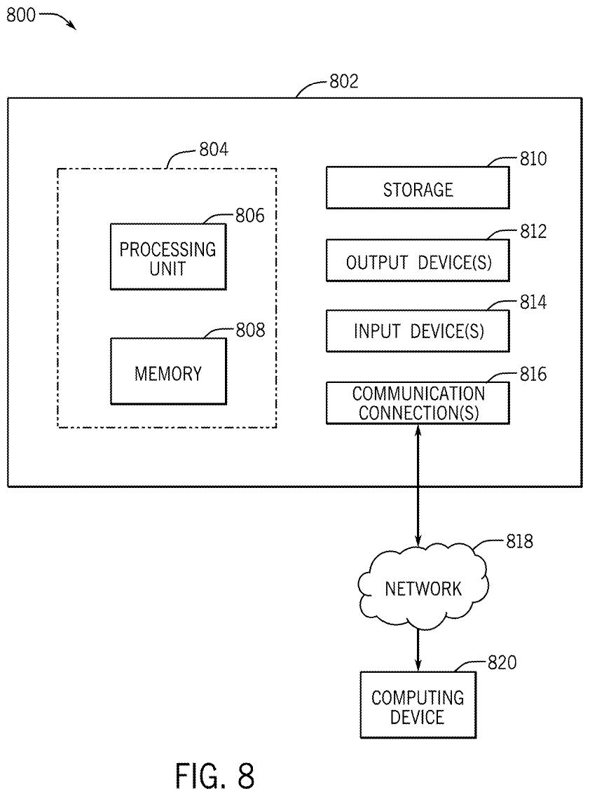

FIG. 8 and the following discussion provide a description of a suitable computing environment to implement aspects of one or more of the provisions set forth herein. The operating environment of FIG. 8 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 8 illustrates a system 800 including a computing device 802 configured to implement one aspect provided herein. In one configuration, the computing device 802 includes at least one processing unit 806 and memory 808. Depending on the exact configuration and type of computing device, memory 808 may be volatile, such as RAM, non-volatile, such as ROM, flash memory, etc., or a combination of the two. This configuration is illustrated in FIG. 8 by dashed line 804.

In other aspects, the computing device 802 includes additional features or functionality. For example, the computing device 802 may include additional storage such as removable storage or non-removable storage, including, but not limited to, magnetic storage, optical storage, etc. Such additional storage is illustrated in FIG. 8 by storage 810. In one aspect, computer readable instructions to implement one aspect provided herein are in storage 810. Storage 810 may store other computer readable instructions to implement an operating system, an application program, etc. Computer readable instructions may be loaded in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 802. Any such computer storage media is part of the computing device 802.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 802 includes input device(s) 814 such as keyboard, mouse, pen, voice input device, touch input device, infrared cameras, video input devices, or any other input device. Output device(s) 812 such as one or more displays, speakers, printers, or any other output device may be included with the computing device 802. Input device(s) 814 and output device(s) 812 may be connected to the computing device 802 via a wired connection, wireless connection, or any combination thereof. In one aspect, an input device or an output device from another computing device may be used as input device(s) 814 or output device(s) 812 for the computing device 802. The computing device 802 may include communication connection(s) 816 to facilitate communications with one or more other devices 820, such as through network 818, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

It will be appreciated that various of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A computer-implemented method for providing in hand robotics dexterous manipulation of an object, comprising:
determining a geometry of an object, a position of the object, and a placement of at least one robotic finger of a robot upon the object;
computing a direction of rolling or rotation of the object by the at least one robotic finger;
updating a position of the object that is manipulated by the robot, wherein the position of the object is updated based on a motion of joints of the at least one robotic finger; and
updating contact points of the at least one robotic finger with respect to contacting the object in a manner that ensures that a viable grasp is enforced to have force closure to retain the object.

2. The computer-implemented method of claim 1, wherein determining the geometry of an object and the position of the object include receiving image data and LiDAR data associated with images and a 3D point cloud of the robot and the object, wherein the image data and the LiDAR data is aggregated and analyzed to determine the geometry of the object and the position of the object as the robot is grasping the object.

3. The computer-implemented method of claim 1, wherein determining the placement of at least one robotic finger of a robot upon the object includes receiving tactile data associated with tactile sensors that are disposed upon the at least one robotic finger and determining contact points that pertain to a specific placement of the at least one robotic finger upon the object.

4. The computer-implemented method of claim 1, wherein computing a direction of rolling or rotation of the object includes determining the direction of the rolling or rotation by a computation of a required motion of joints of the at least one robotic finger to roll or rotate the object.

5. The computer-implemented method of claim 4, wherein computing the required motion of the joints includes computing a Jacobian of the at least one robotic finger at a current joint configuration to transform a motion of the object in the direction of the rolling or rotation into joints motions.

6. The computer-implemented method of claim 5, further including determining at least one contact point of the at least one robotic finger that is to be updated to further roll or rotate the object in the direction.

7. The computer-implemented method of claim 6, wherein at least one command is communicated to the robot to further roll or rotate the object in the direction and to update the position of the object.

8. The computer-implemented method of claim 7, further including determining if a current grasp has sufficient force closure to keep holding the object as it is manipulated.

9. The computer-implemented method of claim 8, wherein at least one command is communicated to the robot to electronically control the at least one robotic finger to complete a required motion of joints based on a computed required motion of joints of the at least one robotic finger to maintain force closure of the object.

10. A system for providing in hand robotics dexterous manipulation of an object, comprising:
a memory storing instructions when executed by a processor cause the processor to:
determine a geometry of an object, a position of the object, and a placement of at least one robotic finger of a robot upon the object;
compute a direction of rolling or rotation of the object by the at least one robotic finger;
update a position of the object that is manipulated by the robot, wherein the position of the object is updated based on a motion of joints of the at least one robotic finger; and
update contact points of the at least one robotic finger with respect to contacting the object in a manner that ensures that a viable grasp is enforced to have force closure to retain the object.

11. The system of claim 10, wherein determining the geometry of an object and the position of the object include receiving image data and LiDAR data associated with images and a 3D point cloud of the robot and the object, wherein the image data and the LiDAR data is aggregated and analyzed to determine the geometry of the object and the position of the object as the robot is grasping the object.

12. The system of claim 10, wherein determining the placement of at least one robotic finger of a robot upon the object includes receiving tactile data associated with tactile sensors that are disposed upon the at least one robotic finger and determining contact points that pertain to a specific placement of the at least one robotic finger upon the object.

13. The system of claim 10, wherein computing a direction of rolling or rotation of the object includes determining the direction of the rolling or rotation by a computation of a required motion of joints of the at least one robotic finger to roll or rotate the object.

14. The system of claim 13, wherein computing the required motion of the joints includes computing a Jacobian of the at least one robotic finger at a current joint configuration to transform a motion of the object in the direction of the rolling or rotation into joints motions.

15. The system of claim 14, further including determining at least one contact point of the at least one robotic finger that is to be updated to further roll or rotate the object in the direction.

16. The system of claim 15, wherein at least one command is communicated to the robot to further roll or rotate the object in the direction and to update the position of the object.

17. The system of claim 16, further including determining if a current grasp has sufficient force closure to keep holding the object as it is manipulated.

18. The system of claim 17, wherein at least one command is communicated to the robot to electronically control the at least one robotic finger to complete a required motion of joints based on a computed required motion of joints of the at least one robotic finger to maintain force closure of the object.

19. A non-transitory computer readable storage medium storing instructions that when executed by a computer, which includes a processor performs a method, the method comprising:
determining a geometry of an object, a position of the object, and a placement of at least one robotic finger of a robot upon the object;
computing a direction of rolling or rotation of the object by the at least one robotic finger;
updating a position of the object that is manipulated by the robot, wherein the position of the object is updated based on a motion of joints of the at least one robotic finger; and
updating contact points of the at least one robotic finger with respect to contacting the object in a manner that ensures that a viable grasp is enforced to have force closure to retain the object.

20. The non-transitory computer readable storage medium of claim 19, wherein at least one command is communicated to the robot to electronically control the at least one robotic finger to complete a required motion of joints based on a computed required motion of joints of the at least one robotic finger to maintain force closure of the object.
